(19) United States
(12) Patent Application Publication
(10) Pub. No.: US 2013/0315713 A1
(43) Pub. Date: Nov. 28, 2013

(54) DEVICE FOR FILTERING FLUID IN A POWER GENERATING SYSTEM

(71) Applicant: Etienne Rene Jarrier, Basingstoke (GB)

(72) Inventor: Etienne Rene Jarrier, Basingstoke (GB)

(73) Assignee: General Electric Company, Schenectady, NY (US)

(21) Appl. No.: 13/477,814

(22) Filed: May 22, 2012

(51) Int. Cl. B01D 29/54; F01D 25/00

(52) U.S. Cl. 415/121.2; 55/482

(57) ABSTRACT

This disclosure describes embodiments of a filter device for use in power generating systems with turbo-machines. In one embodiment, the filter device comprises a two element filter set, having an inner element and an outer element. The inner element resides inside of the outer element to reduce the overall length of the filter device. In one example, the filter device mounts to a wall, or tubesheet, found in an air filter unit of the power generating system.

### BACKGROUND OF THE INVENTION

The subject matter disclosed herein relates to turbo-machines (e.g., gas and/or steam turbines) and, in particular, to filter devices that remove particulates from fluids flowing into the turbo-machine.

Power generating systems may use turbo-machines to drive a generator. During normal operation, the turbo-machines draw in air for combustion. The air passes through a compressor before a combustor mixes the air with fuel and ignites the mixture to drive a turbine.

Contaminants (e.g., dirt, dust, and salt) in the air can reduce performance and efficiency of the turbo-machine. These contaminants can corrode the surface of the compressor blades. The resulting surface roughness decreases air flow and efficiency and, ultimately, reduces both the output of the turbo-machine and the efficiency of the power generating system overall.

Filtration systems remove particulates from the air to combat the effect of contaminants on the power generating system. Examples of these filtration systems may feature a filter device upstream of the compressor. The filter device comprises a filter media to capture particulates before the particulates can reach the combustor. Conventional filter devices often have an elongated body, which secures to a wall, or “tubesheet,” found in the filtration system. A seal is disposed between the tubesheet and wall. This seal prevents unfiltered air from mixing with filtered air that transits the power generating system and into the turbo-machine.

During long periods of operation, particulates may saturate the filter media, which results in a condition that impedes the flow of air and can exacerbate pressure drop across the filter media. The excess particulates may also increase the weight of the filter device. In some case, the additional weight on the elongated body can cause the filter device to sag, thereby pulling the seal away from the tubesheet to allow unfiltered air to flow between the tubesheet and the seal.

The discussion above is merely provided for general background information and is not intended to be used as an aid in determining the scope of the claimed subject matter.

### BRIEF DESCRIPTION OF THE INVENTION

This disclosure describes embodiments of a filter device for use in power generating systems that use turbo-machines. In one embodiment, the filter device comprises a two element filter set, which has an inner filter element and an outer filter element. The inner filter element resides inside of the outer filter element. In one example, the filter device mounts to a wall, or tubesheet, found in an air filter unit of the power generating system. This configuration helps remove contaminants from fluids and, in particular, captures particles in air flowing to the turbo-machine. Some advantages that the practice of embodiments of the filter device is to shorten the overall length of the filter device, which can reduce the likelihood that leaks will occur at the seal between the filter and the tubesheet due to particulate build-up as well as simplify shipping and/or packaging by permitting transport of the filter device in a single container (e.g., box).

The disclosure describes, in one embodiment, a filter device that includes a first filter element having a bore with a central axis and a second filter element disposed in the bore. The second filter element has a surface that tapers from a first diameter to a second diameter, wherein the first diameter is smaller than the second diameter and wherein the first diameter fits inside of the bore. The filter device also includes a mounting element coupled to the second filter element.

The disclosure also describes, in one embodiment, a filter device that comprises a first filter element with a cylinder with a bore and a second filter element disposed inside of the bore. The second filter element has a frusto-conical shape, wherein at least a portion of the frusto-conical shape fits inside of the bore.

The disclosure further describes, in one embodiment, a power generating system that comprises a turbo-machine and an air filter unit coupled to the turbo-machine. The air filter unit has a tubesheet upstream of the turbo-machine and a filter device secured to the tubesheet. The filter device includes a first filter element, a second filter element disposed inside of the first filter element, and a mounting element coupling the second filter element to the tubesheet. In one example, the second filter element comprises a frusto-conical shape that has a first diameter proximate the tubesheet and a second diameter upstream of the first diameter, wherein the first diameter is smaller than the second diameter.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts an exemplary filter device in a power generating system;

FIG. 2 depicts a schematic diagram of a cross-section of another exemplary filter device;

FIG. 3 depicts a side, perspective, exploded assembly view of yet another exemplary filter device;

FIG. 4 depicts a side view of a filter element for use in the filter device of FIG. 3;

FIG. 5 depicts a side view of another filter element for use in the filter device of FIG. 3;

FIG. 6 depicts a side, cross-section view of still another exemplary filter device;

FIG. 7 depicts a mounting element for use with the filter devices of FIGS. 1, 2, 3, 4, 5, and 6; and

FIG. 8 depicts a side view of the mounting element of FIG. 7.

### DETAILED DESCRIPTION OF THE INVENTION

Broadly, embodiments of a filter device for power generating systems comprise a two element filter set with, in one embodiment, an outer filter element and an inner filter element that inserts into the outer filter element. This configuration reduces the overall size of the filter device to simplify installation and maintenance, as well as to facilitate shipping and transporting of the filter device. For example, by implementing this embedded construction, the outer filter element and the inner filter element can ship together, in a single box or package. This feature eliminates the need for separate packaging of the individual components of the filter set. Rather, the configuration of the first filter element and the second filter element permits assembly of the filter device at the manufacturing and/or assembly facility, rather than on-location at the power generating system. Moreover, the assembled filter device has a size that is more manageable for an end user (e.g., a technician) to handle and manipulate during installation and maintenance. This feature can ensure proper fitting and securing of the filter device in position in the power generating system, while also helping to prevent leaks that can occur due to improper installation and, often, due to the build-up of particulates in the filter elements by moving the center of gravity (COG) of the assembled filter device closer to that point at which the filter device secures to a structure.

FIG. 1 illustrates an exemplary embodiment of a filter device 100 (also “device 100”) that can remove particulates from a fluid F (e.g., air). The filter device 100 is part of an array 102, which can include any number of filter devices (e.g., the filter device 100). In its present implementation, the filter device 100 is part of a power generating system 104 with an air filter unit 106, a turbo-machine 108, and a generator 110. The air filter unit 106 has a housing 112 with an inlet 114 and an outlet 116. The housing 112 encloses a wall 118 (also “tubesheet 118”) that is upstream of the turbo-machine 108. Examples of the tubesheet 118 can one or more metal sheets with features (e.g., holes, openings, apertures) to mount the filter device 100 and to permit fluid F to flow through the wall. In one example, as shown in FIG. 1, the filter device 100 mounts to the upstream side of the tubesheet 118 in substantial alignment with a corresponding aperture in the tubesheet 118.

In one example of the power generating system 104, the turbo-machine 108 includes a compressor 120, a combustor 122, and a turbine 124 (e.g., a gas or steam turbine). During operation, the compressor 120 draws air (e.g., fluid F) into the air filter unit 106. The air passes through the filter device 100 and the tubesheet 118 before the air enters the turbo-machine 108. The compressor 120 pressurizes the air, which is subsequently fed to the combustor 122 to mix the air with fuel and ignite the mixture to provide the driving force for the turbine 124.

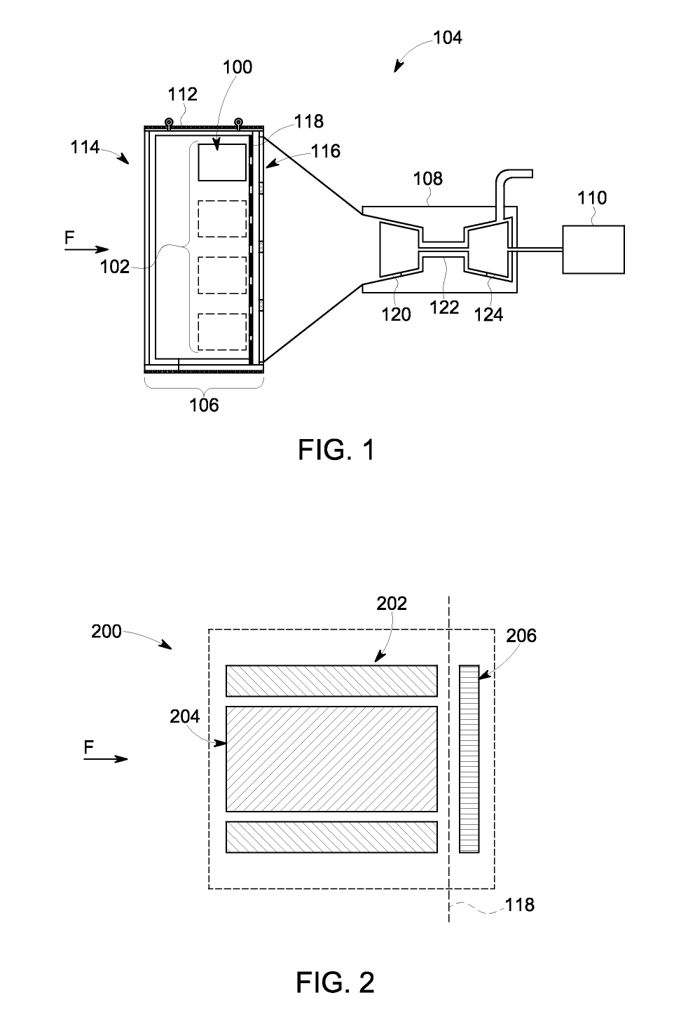

FIG. 2 illustrates a schematic diagram of a cross-section for an exemplary filter device 200 that can remove particulates, e.g., from air that flows in power generating system 104 of FIG. 1. The filter device 200 has a two element filter set (e.g., a first filter element 202 and an second filter element 204). A mounting element 206 provides an interface to mount and secure the filter device 200, e.g., to the tubesheet 118 of air filter unit 106 (FIG. 1). The mounting element 206 couples with tubesheet 118 to support the filter device 200 in the mounted configuration. Examples of the mounting element 206 can secure to one or both of the first filter element 202 and the second filter element 204. However, in one or more constructions, the mounting element 206 has limited, if any, affect on the flow of air that passes through the filter device 200.

The first element 202 and the second element 204 can comprise filter media that allows the collection of particulates on its surface. Exemplary filter media includes fabric filter media, although this disclosure also contemplates materials, e.g., closed cell foams, with properties sufficient to trap particulates without causing undue pressure drop during operation of the turbo-machine. In one example, the filter media has pleats and/or folds distributed throughout the structure of the first filter element 202 and the second filter element 204 to increase the surface area available to capture and hold particulates.

As shown in FIG. 2, the filter device 200 has an embedded structure in which at least a portion of the second filter element 204 resides inside of the first filter element 202. The amount of overlap in the embedded structure reduces the overall size and, in particular, the overall length of the filter device 200, as measured from the tubesheet 118 to the end of the filter device 200. As mentioned above, overlapping the first filter element 202 and the second filter element 204 moves the center of gravity (COG) of the filter device 200 closer to tubesheet 118 as compared to convention filter devices with elongated bodies that comprise separate filter elements that abut, rather than overlap, with one another. The proximity of the COG to tubesheet 118 reduces the cantilevered load on the mounting element 206 when the filter device 200 is in its mounted configuration, thereby reducing the risk of air leaks that can form at the interface of the filter device 200 and tubesheet 118 especially under conditions in which the filter media is saturated with particulate matter.

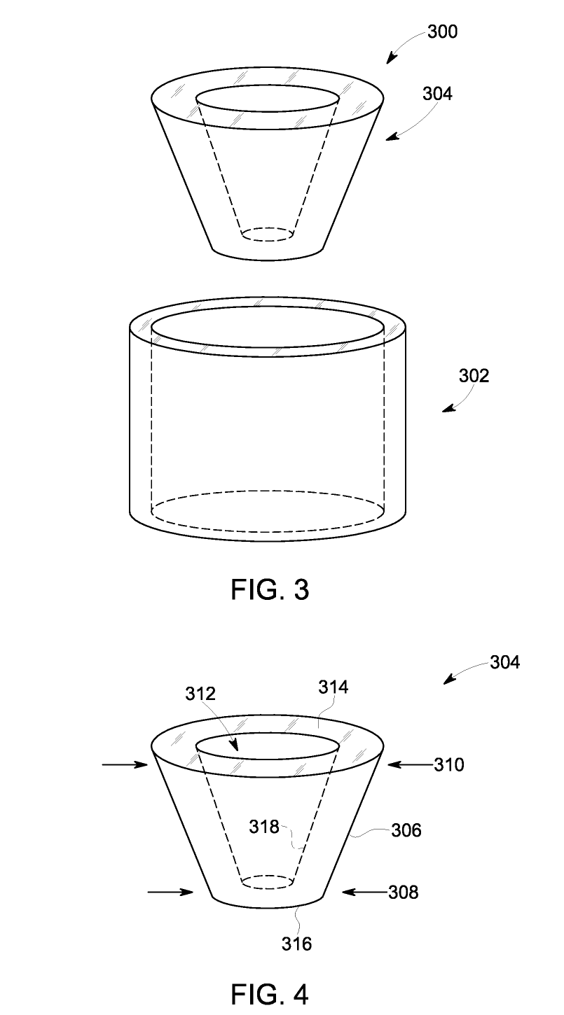

FIGS. 3, 4, and 5 show another exemplary filter device 300. Referring first to the exploded assembly view of FIG. 3, the filter device 300 includes a first filter element 302 and a second filter element 304 that fit together to permit the first filter element 302 to slide into, or embed within, the second filter element 304. This feature reduces the overall length of the filter device 300. Constructions for the first filter element 302 and the second filter element 304 can incorporate filter media. In certain examples, the filter device 300 can include other structures that support the filter media, thereby forming the general shape of the first filter element 302 and the second filter element 304. These structures can include a framework of rigid frame members that support the filter media. The framework can also provide mounting points and/or mounting features, e.g., frame members that receive mounting element 206 of FIG. 2.

The first filter element 302 and the second filter element 304 can have various form factors that facilitate the overlapping structure. These form factors can also offer adequate qualities that coincide with the desired characteristics (e.g., size, pressure drop, filter efficiency, etc.) of the filter device 300. As shown in FIG. 3, the form factor of the first filter element 302 can comprise a cylindrical shape. The form factor for the second filter element 304 can permit the embedded structure of the filter device 300. In FIG. 3, for example, the form factor of the second filter element 304 can comprise a frusto-conical shape. This disclosure also contemplates construction of the first filter element 302 and the second filter element 304 with other shapes, e.g., cubes, rectangular, elliptical, and combinations thereof.

As best shown in FIG. 4, the second filter element 304 has an outer surface 306 that tapers from a first diameter 308 to a second diameter 310, which is larger than the first diameter 308. The second filter element 304 can also include a first bore 312, which extends from a first open end 314 to a second open end 316. The first bore 312 can have an inner surface 318 that tapers at an angle corresponding to the angle of taper for the outer surface 306

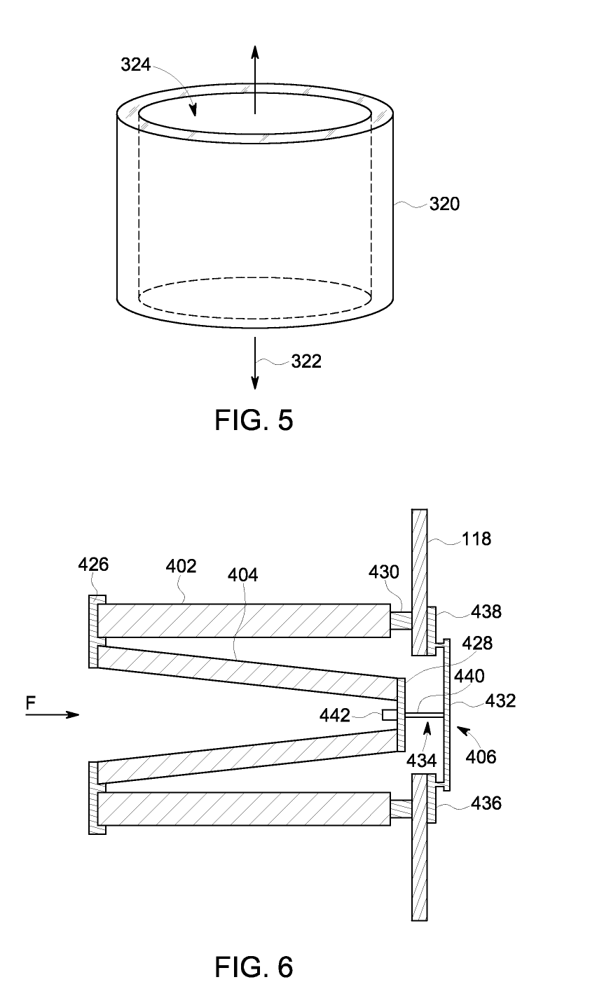

The first filter element 302, as shown in FIG. 5, has a wall 320 that forms a cylinder with a central axis 322. A second bore 324 extends through the cylinder. The second bore 324 is sized to receive at least the first diameter 308 of the second filter element 304 (FIGS. 3 and 4). Moreover, in one embodiment, the second bore 324 can receive the second diameter 310 of the second filter element 304 (FIGS. 3 and 4), a feature which allows the second filter element 304 to insert into the second bore 324 of the first filter element 302.

FIG. 6 shows a cross-section of another exemplary filter device 400 in a mounted configuration on tubesheet 118 (FIG. 1). The filter device 400 includes a first filter element 402, a second filter element 404, and a mounting element 406. The filter device 400 also includes a framework that comprises, in one example, a first end cap 426 and a second end cap 428. The framework secures the first filter element 402 to the second filter element 404 to form the assembled device 400. In one example, the filter device 400 also includes a seal element 430, which secures a face of the first filter element 402.

In one embodiment, the mounting element 406 includes a central support member 432 with a fastener element 434. The mounting element 406 can also include one or more leg members (e.g., a first leg member 436 and a second leg member 438). Examples of the fastener element 434 can have a bolt member 440 that penetrates through the second end cap 428 and a nut 442 that secures to the bolt member (e.g., on the inside bore and/or cavity of first filter 402).

The seal element 430 forms an air tight seal to prevent air from leaking from gaps or openings between the end of the first filter element 402 and the tubesheet 118. Examples of the seal element 430 can comprise various compressible materials, e.g., polymer-based materials and/or other materials that are typical of gaskets and o-rings to form the air tight seal. In one construction, the seal element 430 is part of, or incorporated into, the first filter element 402.

The framework (e.g., the first end cap 426 and the second end cap 428) can comprise metals (e.g., aluminum) and plastics, as well as composites and other materials as desired. Examples of the first end cap 426 can generally form an annular ring that adjoins the filter elements (e.g., the first filter element 402 and the second filter element 404) without blocking airflow F through the filter device 400. On the other hand, the second end cap 428 can comprise a solid disk that can both strengthen construction of the second filter element 404 and provide a location to mount, e.g., the mounting element 406.

The first filter element 402 and the second filter element 404 can comprise filter media, which as discussed above captures particulates as the airflow F penetrates through the filter device 400. The filter media may be of the same type, e.g., with of the first filter element 402 and the second filter element 404 having filter media with a rating to filter particles of a certain diameter. In other embodiments, the filter media may be different as between the first filter element 402 and the second filter element 404. In one example, the first filter element 402 and the second filter element 404 can be constructed as a monolithic structure, wherein the filter media forms a uniform, and/or substantially uniform, structure for both of the first filter element 402 and the second filter element 404. Monolithic construction (as well as some constructions of the filter device) may avoid use of one or more of the first end cap 426 and the second end cap 428.

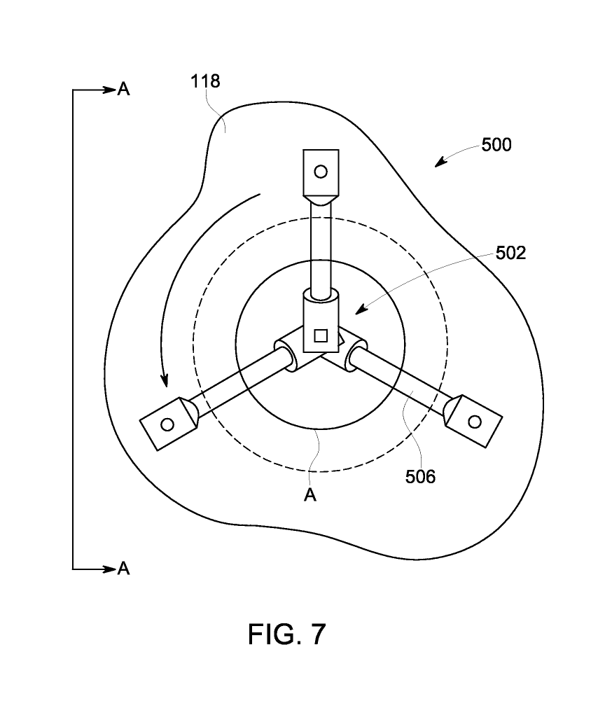

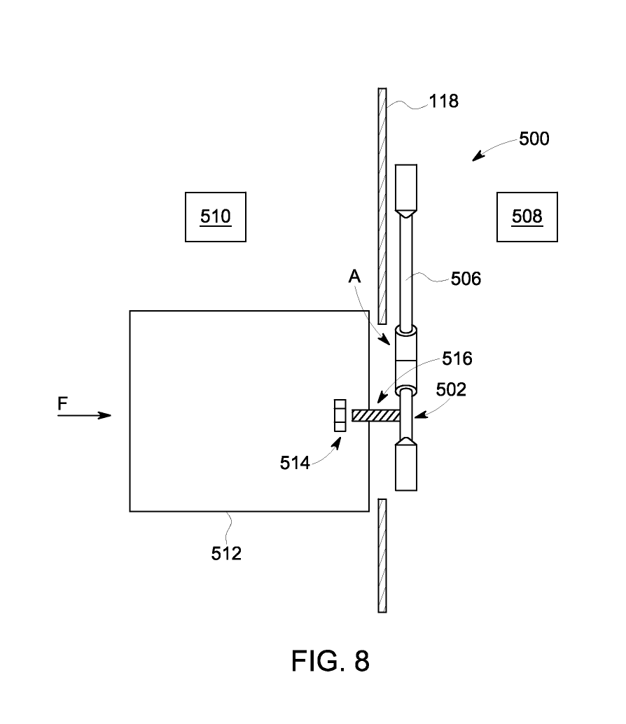

FIGS. 7 and 8 depict an example of a mounting element 500 to mount filter devices (e.g., filter devices 100, 200, 300, 400) as discussed herein. FIG. 7 shows the mounting element 500 on the downstream side of tubesheet 118. An aperture A is also shown. The aperture A is formed in the tubesheet 118 to permit air to flow, e.g., through to a turbo-machine. The mounting element 500 has a tripod configuration with a central member 502 and an array 504 of leg members 506 radiating therefrom. The array 504 can have any number of leg members 506. In one example, the leg members 506 can be approximately equally radially spaced from each other. As shown in FIG. 7, if the array 504 has three leg members 506 in the tripod configuration, each leg may be spaced at approximately 120° from each other.

FIG. 8 shows a side view of the mounting element 500 taken at A-A of FIG. 5. As shown in FIG. 8, the mounting element 500 resides on the downstream side of tubesheet 118, as generally identified by the numeral 508. Embodiments of the filter device 512 reside on the upstream side (e.g., side 510) of tubesheet 118. In one example, the mounting element 500 includes a nut element 514 that mates with a corresponding threaded element 516 (e.g., a bolt). This combination of elements secures the mounting element 500 to the filter device, e.g., to second end cap 428 of FIG. 6.

One or more of the elements of the mounting element 500 can be formed monolithically, as a single integrated structure. In other alternatives, the elements can comprise separate pieces that are assembled together using know fasteners and techniques. Construction of the mounting element 500 can use metals, plastics, and composites. Generally, suitable materials having mechanical properties to support the weight of the filter device 518 in the cantilevered configuration shown in FIG. 8.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A filter device, comprising:
a first filter element having a bore with a central axis;
a second filter element disposed in the bore, the second filter element having a surface that tapers from a first diameter to a second diameter, wherein the first diameter is smaller than the second diameter and wherein the first diameter fits inside of the bore; and
a mounting element coupled to the second filter element.

2. The filter device of claim 1, wherein the first filter element has a cylindrical shape.

3. The filter device of claim 1, wherein the second filter element has a frusto-conical shape.

4. The filter device of claim 1, wherein the second diameter of the first filter element fits inside of the bore.

5. The filter device of claim 1, further comprising a seal element disposed on a face of the first filter element, wherein the face forms a plane that is perpendicular to the central axis of the first filter element.

6. The filter device of claim 5, wherein the seal element comprises a annular gasket that circumscribes the central axis to seal the face of the first filter element to a tubesheet in a filter housing of a power generating system.

7. The filter device of claim 1, wherein the mounting element comprises a central member and a plurality of leg members radiating therefrom, and wherein the central member couples with the second filter element.

8. The filter device of claim 1, further comprising a first end cap coupling the inner filter element to the second filter element and a second end cap disposed on the second filter element, wherein the mounting device couples to the second end cap.

9. The filter device of claim 1, where the first filter element and the second filter element are formed from the same filter media.

10. The filter device of claim 1, wherein the first filter element and the second filter element are formed monolithically.

11. A filter device, comprising:
a first filter element comprising a cylinder with a bore; and
a second filter element disposed inside of the bore, the second filter element having a frusto-conical shape, wherein at least a portion of the frusto-conical shape fits inside of the bore.

12. The filter device of claim 11, further comprising a mounting element coupled to the second filter element, the mounting element comprising a central member that secures to an end of the second filter element and a plurality of leg members radiating from the central member.

13. The filter device of claim 11, further comprising a first end cap coupling the first filter element and the second filter element.

14. The filter device of claim 11, further comprising a seal element disposed on a face of the first filter element to seal the face to a planar surface.

15. A power generating system, comprising:
a turbo-machine;
an air filter unit coupled to the turbo-machine, the air filter unit comprising a tubesheet upstream of the turbo-machine and a filter device secured to the tubesheet, the filter device comprising a first filter element, a second filter element disposed inside of the first filter element, and a mounting element coupling the second filter element to the tubesheet,
wherein the second filter element comprises a frusto-conical shape that has a first diameter proximate the tubesheet and a second diameter upstream of the first diameter, wherein the first diameter is smaller than the second diameter.

16. The power generating system of claim 15, wherein the first filter element forms a cylinder with a bore, and wherein the first diameter of the frusto-conical shape fits inside of the bore.

17. The power generating system of claim 15, wherein the filter device comprises a seal element disposed between a face of the first filter element and the tubesheet.

18. The power generating system of claim 15, wherein the filter device is part of a filter array.

19. The power generating system of claim 15, wherein the mounting element comprises a plurality of leg members in a tripod configuration.

20. The power generating system of claim 15, wherein the filter device comprises a first end cap coupling the first filter element and the second filter element together proximate the second diameter of the frusto-conical shape.
